(19) United States
(12) Patent Application Publication
(10) Pub. No.: US 2018/0253216 A1
(43) Pub. Date: Sep. 6, 2018

(54) SYSTEM FOR CONSUMPTION AND GENERATION OF MEDIA BY VISUALLY IMPAIRED

(71) Applicant: GARY BEENE, DALLAS, TX (US)

(72) Inventor: GARY BEENE, DALLAS, TX (US)

(21) Appl. No.: 15/913,393

(22) Filed: Mar. 6, 2018

Related U.S. Application Data
(60) Provisional application No. 62/467,335, filed on Mar. 6, 2017.

(51) Int. Cl. G06F 3/0481; G06F 3/0482; G06F 3/0488; G06F 3/0489; G09B 21/00

(52) U.S. Cl. CPC G06F 3/04817; G06F 3/0482; G06F 3/04886; G09B 21/008; G06F 3/04897; G09B 21/006; G09B 21/007; G06F 3/04895

(57) ABSTRACT

The present invention is a system and method to enable visually impaired persons to consume and generate media, digital and non-digital, from multiple sources, using a computer, hardware and software components. To minimize visual distractions and screen content unreadable to persons with visual impairments, the system conceals the underlying operating system, presenting a replacement interface with minimal but large icons with standard images, large text, contrasting colors, oral recitations, reduced command sequences and vertical scrolling that enables media consumption by such persons. The system presents text, images and video from multiple media sources, creates real time digitization of content, facilitates communications between normal and visually impaired users, and allows navigation and operation via verbal commands, touch screen, remote control or keyboard and mouse. Content introduced to the system via email or storage media is automatically downloaded and prepared for viewing. The system provides remote technical access for repair and troubleshooting.

### BACKGROUND

The present invention relates generally to methods and devices for aiding the consumption and generation of media by visually impaired persons.

Many people have visual impairments that prevent the consumption or generation of media content for personal and business uses and communication. These limitations may be due to health, age or other conditions affecting the health and function of the eyes. There are many visual and audible aids available to assist those with vision issues, such as hand-held magnifiers, large font keyboards/phone/devices, document cameras with zoom, CCTV video projection systems, electronic magnifiers, special lighting tools as well as other options. However, these options do not eliminate distractions, unreadable screen content, or unreadable printed materials; eliminate the requirement of basic computer skills; or provide access to a voluminous and/or varied library of reading, viewing and audible materials. Visually complex (i.e. high density, small size) screen elements from other applications within the operating system that visually complicate the screen, i.e. create distractions, make screen viewing difficult for the visually impaired user. While devices and apps such as Kindle and online magazines do offer the ability to control font size, they do not eliminate distracting/unreadable multiple small icons, images and text, particularly advertisements and navigation aids. These elements of distraction or other unreadable content are often displayed in addition to the content obstructing the reading and viewing material and accessibility of the visually impaired user. Further, a reader must magnify content prior to consumption by sweeping left to right, row by row. Users with visual impairments often suffer disorientation with horizontal movement, making the horizontal orientation inappropriate as a content display method. By contrast, the present invention utilizes a real-time text wrapping function so that the text is rearranged in vertical display that can be read from top to bottom, wherein the user only moves within the system, vertically from page to page.

The present invention, a System for Consumption and Generation of Media by Visually Impaired (the “EZReader”) completely eliminates these visual distractions by controlling the full screen of the PC and only using large on-screen objects, consistent with the visual limitation of the visually impaired user. Further, the present invention minimizes the requisite level of computer skills required to read/watch/view/generate content, such as sending/receiving emails and text messages. While using the present invention, a user will only interact with a limited number of screen elements, such as command icons (especially compared to traditional interface options on technical devices) to operate/navigate the features of the present invention. Additionally, the command icons displayed on the present invention contain industry standard images, are commonly used and understood, and are likely self-explanatory to most users. The present invention also provides access to multiple sources of content such as various digital files, printed materials like magazines, books, newspapers, photographs as well as music files, music sharing websites and video streams, including over the air television and radio content. Currently available devices typically function with a single content source, which requires users to purchase multiple devices to satisfy all of their informational desires. The present disclosure compiles content from multiple sources and makes that content accessible to the user through a single platform. The platform includes a suite of modified applications to replace similar applications from common operating systems, which are often unusable by users with visual limitations. EZReader's modified applications are specifically tailored for use by visually impaired persons.

### OBJECTIVES

An object of one embodiment of the present disclosure is to provide a system for visually impaired persons to consume and generate media content from multiple sources in digital or non-digital formats, including the use of a real-time digitization algorithm and OCR engine.

Another object of the present disclosure is to provide a platform for the visually impaired free from the unreadable clutter of a typical operating system and applications of that operating system.

Another object of the present disclosure is to provide an intuitive system for viewing text and images that does not require computer skills above a basic level.

Another object of the present disclosure is to provide a system that only requires icons and touch screen input, but optionally allowing conventional keyboard and mouse usage, to facilitate consumption and generation of media for visually impaired persons.

Another object of the present disclosure is to provide a system that is ready for use upon the powering up of the system.

Another object of the present disclosure is to provide support for real-time consumption and generation of content, including but not limited to, hi-speed, real-time algorithms for word-wrapping of wide content to allow vertical scrolling of large text content, and hi-speed, real-time algorithms for conversion of frames from full-speed video streams to binary colors, which are compatible with the users who have visual limitations.

Another object of the present disclosure is to provide media to visually impaired persons using novel screen and applications designs which provide readable content in a convenient and visible format such as screen element density, brightness, font selection, unlimited text size, high contrast colors, controlled screen image size, and multiple oral recitations.

Another object of the present disclosure is to provide remote access to tech support for users of the system, including ease of activating the remote control.

Another object of the present disclosure is to provide portable versions of the system with the same functionality as the full system and to transfer content wirelessly between computer and portable devices while accessing the greater processing of the computer component.

Another object of the present disclosure is to provide methods for controlling applications within the underlying operating system by overriding their navigation system with the same navigation system used in the custom EZReader applications, such as displaying the Windows 10 Internet browser but controlling it with an EZReader command button toolbar.

Another object of the present disclosure is to provide methods of automatically exchanging, importing or exporting content between users with normal vision and users with vision limitations such as by automatic detection of inserted mobile devices or by automatic detection and extraction of email media attachments.

Another object of the present disclosure is to redefine the process flow for content consumption and generation to eliminate steps which are inherently incompatible with users with limited vision.

Another object of the present disclosure is to provide the user the option to control navigation and application operation using verbal commands, consistent with the minimal command icon design strategy.

Another object of the present disclosure is to assist the user in automatically adjusting settings for optimal visibility, eliminating the need for trial and error and user judgement for optimizing content display parameters.

Another object of the present disclosure is to provide low vision compatible tools with which to monitor the health of the users, as it relates to their physical conditions which affect their ability to consume and generate media, including the monitoring of trend data for sharing with a medical professional.

Another object of the present disclosure is to support multiple users on a single installation of EZReader by means of user accounts which separate user settings and user generated content.

Another object of the present disclosure is to enable customization of the launch pad, enabling users to see only those EZReader features which they expect to use.

Another object of the present disclosure is to enable the use of EZReader by fully blind persons by enabling navigation of graphic screens via keyboard and with oral confirmation of actions taken.

Another object of the present disclosure is to provide an automated installation of the system made possible by insertion of the distribution media into a slot, where EZReader will then automatically activate and complete installation of the system with a single approval by the user.

### SUMMARY

Embodiments of the present disclosure, a System and Method for Consumption and Generation of Media by Visually Impaired (the “EZReader”), provide a system and method to enable visually impaired persons to consume media from multiple sources and to generate media for archive and distribution purposes using computer hardware and software components. EZReader provides a system and method for people with vision impairments to read, watch, view, consume and generate media content. Media sources include, but are not limited to, digitized media, paper media, oral media, and transmitted media (i.e. television (TV) and radio). The EZReader may be customized to provide the output best suited to each particular user's abilities and limitations. For instance, the font size, boldness of text, colors of text/background, width of scroll bars, size of screen, brightness of screen, paragraph wrapping, full width display, cursor color, language, male/female voice for audible, underlined text, full width, and word wrap, may all be adjusted by the selection of a particular icon within EZReader.

The present system utilizes a combination of hardware, custom software, and a computer system, to enable a user to consume and generate various forms and types of media content. The system utilizes advanced algorithms to minimize computing requirements to respond to user inputs. The algorithms further enable the use of less advanced, less costly and smaller hardware to operate the system. The user interface of the system consists of mainly large text and images, high-contrast between text and background colors and large command icons. The user is protected from inadvertent exposure to the operating system since the underlying operating system is not visible to the user unless specific steps are taken to access the operating system. In addition, the system is intuitive and does not require user experience or proficiency with computers, technology or common operating systems. The EZReader may be customized to provide the output best suited to each particular user's abilities and limitations. The user interface of EZReader may also be customized to display only those features which the user intends to use, removing features from the interface which the user doss not intend to use, including content of screens and the navigation toolbar.

EZReader may include but is not limited to modified applications for the following functions: Technical Support, LaunchPad, Electronic Books, Dictation, Notepad (Text Editor), Email, Health, Games, Camera, Video, Spreadsheet, Television, Radio, Internet website, Internet music, Photo Gallery, Music Player with stored music files, Stored links for favorite websites, Calculator, Weather, Calendar, Clock, Alarms, System settings, System Files Editor, Saved books. The EZReader display unit can the adapted for wall mounting, table top or desktop to use with a variety of screen sizes. The present system may also be adapted for smart phones and tablets. The portable versions of the system may incorporate the automatic transmission of content, such as text and images via wires or wirelessly from the device to the EZReader software on the PC. The screens may include touch screen abilities. Touch screen options include touching a particular icon, and gestures, such as increasing or decreasing distance between fingers to increase or decrease size of content on screen, such as text or images. The EZReader is compatible with add-on devices such as camera for images or text, electronic mouse to replace selection via touch screen, TV and radio tuner/antenna for broadcast shows, mounting arm, and video capture cards to the user's computer or other media. When the time comes to update the software for the present system, those updates can be downloaded to the system with the selection of the “online update” icon. Once the update icon is selected, the download and installation of the software completes without user intervention.

The system presents and transmits text, images and video from and to multiple media source formats. System presentation of content includes real time digitization of content or media where such digitization may be implemented using cameras, OCR (optical character recognition) software, and other media filtering or processing mechanisms, with real time processing. Content density (visual complexity) is optimized to be compatible with the limitations of users who are visually impaired. In addition, EZReader uses broadcast messages for inter-application communications. A broadcast message can be received and read by multiple applications in contrast to a normal message, which requires that the sending application know the handle (i.e. a number assigned to the application by Windows) of the receiving application. The sending application can also prepare and send a single message to all applications instead of individual messages for each application. When two applications register a message using the same text string, they both are given the same unique number by Windows. In operation, those applications watch for a message from Windows by that unique number. Applications which do not register a message with the same text string will not know what message number has been assigned and so cannot know when that broadcast message is sent out by Windows.

The system conceals the underlying operating system to minimize the computer skills required by the user and to isolate the user from the visual complexity presented by the underlying operating system user interface. Isolation is achieved through a user interface which completely fills the computer screen. The user may drop to the underlying operating system but only through a specific set of actions intended to prevent unintended access to the underlying operating system.

The system replaces all operating system applications through which the user consumes and generates media (i.e., modified email, weather, calendar, camera, note pad, electronic book, web browsing, etc.). Unlike the replaced applications of the standard operating system, the replacement applications are tailored to meet the requirements of visually impaired users, i.e., significantly lowered visual complexity while maintaining the primary application features. The replacement application can communicate with the replaced applications, allowing the user to communicate with persons who do not have visual impairments and who are using the replaced applications. The replacement applications maximize ease of use by using alternate information handling process flows which eliminate steps normally included in media content transfer and storage. This Includes the use of pre-assigned content and settings optimized to the visual limitations of users, with the further ability to automatically optimize to a specific user. Information density can additionally be customized on a per user basis to ensure that visual complexity of the presented content is consistent with the needs of specific users.

The system enables ease of use in communication between user types by the automatic recognition of the insertion of mobile media (i.e., flash drives) and the transfer of media content to the system without user intervention. EZReader automatically backs up all files to portable media, such as a flash drive once the media is inserted into the computer, including those files added to the system by the user after the installation of EZReader. Presentation of information to users of both types (with or without visual limitations) is facilitated by the use of multiple content formats.

The system allows the use of icons for all navigation and screen control actions, eliminating the need for the user to use a keyboard or mouse. The system additionally recognizes verbal commands, equivalent to the actions available via icon navigation. Customized onscreen keyboards allow for entry of text content. In all methods of command/data entry, the system provides mechanisms for filtering out unwanted replicate commands, including multiple audible/visual notifications of commands, rejection of non-command audio inputs, and the placement of limits on the time between commands. The system minimizes the number of icons and shares icons between system applications to facilitate ease of use by the user and to reduce the burden of memorizing icon types. Icons use industry standard images which are self-explanatory in nature.

Both the Launch Pad (home screen) and the navigation bar at the bottom of the screen are customizable for each application within EZReader. When the system is powered on, the user may see multiple icons on the Launch Pad for applications such as “Books, Email, Video, Internet, Gallery and Other,” corresponding to the features of EZReader, which the user has elected to view. In addition, the EZReader includes a navigation tool bar for each application or screen with large touch button icons, including but not limited to: exit, power, home, books, menu, up, down, volume, mute, increase/decrease view size, increase/decrease contrast as well as other icons, which allow the user to navigate and operate the application. While there are over one hundred and fifty (150) EZReader icons available, only fifteen (15) may be shown at once and commonly only five to ten (5-10) icons are typically visible on the toolbar. The user will not be distracted or disturbed by clutter such as pop-up ads, banner ads, videos, icons pinned to the desktop for quick reference or new windows or applications that have been opened, as are present on the underlying Windows operating system. None of these common distractions are permitted to invade the visual experience of EZReader, which reduces the visual complexity of the screen content viewed by the user. Any user who wants to access the features of the underlying operating system will need to exit the EZReader platform. Further a mouse and keyboard are not required to interact or enter input into the EZReader systems or its applications. Features of EZReader include but are not limited to: simple navigation within the system, low visual complexity, unlimited font sizes, high contrast colors, text to speech reader, visual and audible user feedback on actions and navigation. The launch pad may have multiple formats, including graphical and/or text. From the text Launch Pad, the user can scroll up or down with the arrows in the navigation bar. As the user scrolls, the highlighted text will be read aloud. The user can press <enter> to open the highlighted or selected application. Blind and legally blind users may find this text-based launch pad particularly useful. The graphical Launch pad displays words and navigation icons which the user can see and touch or click to navigate to the indicated application. Once text or images are selected, the EZReader application associated with the selection will open or be launched.

With respect to the internet, EZReader includes a built-in browser to accommodate visually impaired users but users may still access the standard operating system default browser, that is likely already installed on the computer. The EZReader browser has an icon bar for the selection of pre-determined URLs (based on user input and preference), where each icon is large and easily viewable, so that EZReader users can still access those websites that require industry standard browsers such as FireFox, Chrome, Explorer, etc.

The system may be utilized by users with minimal computer skills or experience. The present system is always in an on and ready to operate mode in order to facilitate quick access by the user. Content selection and navigation may be performed using only touch screen commands without the requirement of the keyboard or mouse for input purposes. Users may input into EZReader using touch screen, keyboard, mouse, verbal commands, remote controls or other devices. Through these input devices, a user may adjust settings, open applications, and work within applications to produce a certain output on the EZReader screen. However, if an EZReader user is proficient with a keyboard and mouse, then the user may choose to use those devices to interact with the EZReader system. The cursor for the mouse is at least ten times as large as the traditional mouse cursor available on commonly used operating systems in order to accommodate the visual impairments of EZReader users.

If the system detects an extended period of inactivity, the system will go dark or to a screen saver to prevent any illumination from distracting the user or to provide a soothing or entertaining animation for the user to watch. Once the system is touched, it will return to full ready mode instantly without further user intervention. Consumption of digital content using the EZReader system results in a higher quality viewing experience than physical media, which requires camera zooming, since digital content allows distortion-free zooming, eliminates horizontal scrolling and enables content color/font control.

The present system also uses a unique word-wrapping algorithm which allows vertical scrolling to read or view text. EZReader wraps word by word, line by line or paragraph by paragraph. For the visually impaired, line wrapping is more suited to lists and paragraph wrapping for content with paragraphs, such as books, email and text file content. The high-performance, real-time digitization algorithm can also be applied to video streams. EZReader word wrapping algorithm works by inserting a single unique character between words, where that unique character is recognized by EZReader code as an “end-of-line”. This single unique character replaces the space character that words already have between them. EZReader eliminates the need to copy the original text and instead replaces the spaces between words with the new “end-of-line” characters wherever the word wrapping algorithm indicates an “end-of-line” character is needed to start a new line. Eliminating the copy aspect of word wrapping reduces the processing time of lengthy text down to milliseconds.

By contrast, traditional readers require the user to horizontally scroll sections of text from left to right and then move to the next line of text and repeat (i.e. horizontal scrolling). Text strings, such as the content of a book, include two hidden characters, which the reading software recognizes as the start of a new line. Normal word wrapping splits up the original text content into new lines which will fit within the width of the screen and places the same two hidden characters between lines. The process of splitting normally involves creating a new copy of the original content with pairs of characters placed wherever a new line is to be formed. When the splitting is done, the new copy, which is slightly larger than the size of the original copy, is used for display purposes. The creating of a new copy is a relative slow process, particularly for books with millions of characters. Normal processing times for such lengthy text can be seconds as compared to milliseconds with EZReader's word wrapping algorithm.

External video sources, such as NTSC video fed through the computer USB ports, can be displayed through the present system. Video content can be filtered by the present system to facilitate viewing by converting content to high contrast, binary colors most suited to a particular user, which enhances visual contrast and limits content to two colors.

The system provides a digital zoom option to view printed media for cases where digital content is not available. For instance, the present system uses cameras for the viewing of printed materials such as current content (books, newspapers, magazines) without regard to the format of the media. Cameras may also be used for real-time magnified viewing in the performance of personal activities (such as application of makeup, tweezing or shaving) and taking photos of others or snapshots (i.e. selfies) sent via email or saved to a computer or storage device. With the present system, any book, daily newspapers (such as provided by the National Federation of the Blind Newsline service or paper copies), Kindle books (or similar electronic books) purchased or downloaded by the user, and content from The Library of Congress and other libraries may be readily viewed by the visually impaired user. For printed content, the present system can digitize the content, then display the digitized content with non-distortion zoom and high contrast features to facilitate media consumption by the visually impaired user. EZReader can also modify the received content with navigation links (intra-document: to move through the document), content links (inter-document: to access internet content related to particular passages of text), and chapter markers (to mark specific chapters or pages of a book). These modifications to the media content are made after the content is received, stored, and displayed in EZReader and are not available for content consumed outside the EZReader system.

After a snapshot or photo is taken, the OCR (optical character recognition) of the EZReader will extract the text from the image and display in digital format. This digital data may be zoomed and viewed without distortion. Users of the present system will have access to a free book library featuring a selection of books in the public domain, which are not protected by copyright. For instance, the Gutenberg project provides digitized copies of over 35,000 books with expired copyrights. EZReader can immediately download any of these books, view a list of available titles, search for specific terms within author name and book title. In addition, system users may also add their own textual content such as books, magazines, e-books, newspapers and other periodicals. These libraries of materials may be updated by the systems as updates become available. The system may also display internal and external camera video streams. For instance, books and music received by email or saved to flash drive inserted into the computer will automatically be downloaded and stored in the EZReader library. The present system may also be used to play common games, modified for users with visual impairments, (i.e. solitaire, mine sweep, video games, etc.), view PDF files as well as other content sources such as “Daisy” formatted media (standard form of audio and braille books).

Additionally, the present system also incorporates a custom email system for users which can display text, images and attachments, as well as to send both email and text messages. Two email clients are provided, one with full email client features and one with send-only capability. The send-only email client provides additional features which enable the user to more quickly send emails, including user pre-defined email and text message content. For example, with send only email, a user might only send messages such as “what time will you arrive?”, “when is my appointment?”, “what's for dinner”, and “what time is the concert?” Each EZReader user can customize the messages in the send-only email application based on their own commonly used phrases.

The system also allows its users to view images or photographs as a slideshow presentation. Images may also be viewed from internet sources as well as reading material or from email attachments or snapshots taken from the EZReader video application. Once a photo is saved to the Gallery, the photo is automatically resized and saved in real time, in multiple sizes for quick access and future sharing by the EZReader user. For example, the photo may be resized to 25%, 50%, 75%, 125%, 150%, etc. The automatic resizing of photos stored in the Gallery results in significant decrease in the time required to display the resized image, as compared to converting the original, larger image to a new size each time the image is viewed. Image sharing from the phone/tablet application allows the user to move about the system, share images with others and transfer the image to the PC, where more powerful image processing/filtering can be accessed.

Users can also search all digital content in written media, such as books, magazines, emails, by keyword with the EZReader by typing search terms in the dialogue box. Users can also select an oral recitation option within the system, wherein the media will be read aloud for consumption by the user. As materials are read to the user, the system can highlight in multiple ways, the materials which have been read or are being read. EZReader includes several options to personalize the oral recitation voice: gender, country of origin, and speaking speed. In addition, EZReader includes a Listener application (i.e. dictation) for speech to text conversions. The words spoken from television, radio, telephone, or conversations in the vicinity of the EZReader user may be transcribed once the dictation application is activated by the user. The transcripts of that content will be stored in a text file that contains the history of all recorded content and may be accessed by the user via oral recitation or reading and searching using EZReader applications.

The EZReader also contains certain health diagnostic tools to help a user monitor changes in vision or other health conditions which may have subsequent effects on vision. These applications are not a replacement for medical treatment or diagnosis but may assist a user in making a determination that a doctor's appointment should be scheduled. The health diagnostic tools include, but are not limited to, the taking of standard vision tests, taking photos of the user's retina and sending those images to the user's doctor for review and further consultation, and the automatic selection of an optimal high contrast color pair for content display. Additional hardware such as eye charts, retina scanner, or other equipment may be connected to EZReader to enable these functions.

EZReader includes a modified calendar application as well to accommodate visually impaired users. The EZReader calendar application allows merging between the EZReader user's calendar and the calendars of selected contacts of the EZReader user. The user can add events and appointments to the calendar via on-screen touchscreen keyboard or physical keyboard, implement the oral recitation application to hear what is on their calendar, and view the calendar entries using EZReader.

EZReader weather application allows the user to choose the number of days in a forecast, such that fewer days result in a larger display font. EZReader modifies forecasts to eliminate voluminous forecast content and instead displays short, concise descriptions or common abbreviations and self-explanatory icons (rain, sun, hot, cold, etc.) These simplistic forecast contents are easily consumable by the visually impaired.

System users may also use the remote access option in order for the help center to remotely access, diagnose and repair the computer or demonstrate EZReader operations. For technical support within EZReader, a user may access the built-in help screens, context menus, multiple audible action indicators, live help desk support, or a list of frequently asked questions. Technical assistance may be reached by clicking the help icon or via phone, email or text message. Once the request for assistance is submitted to the system help center, the user will be identified to the help center with the user's contact information. While this embodiment uses third party software, Team View, any similar software platform could be used to achieve a similar result.

The present system incorporates television and radio, including remote control, with the same icons, and corresponding functionality, as other EZReader system applications. The present system includes a TV selection icon to enable viewing of television stations from broadcast and cable stations. Generally, the TV component can display television, either from over-the-air (antenna), a cable source, or a recorded source such as DVR or on demand. Typically, a USB tuner is required for this functionality in EZReader, wherein the tuner incorporates reception of both TV and radio content. However, the manufacturer's software that typically accompanies the USB tuner when purchased is unsuitable for persons with low vision. The present system provides custom software that replaces the manufacturer's software and makes channel selection by a low vision person using EZReader convenient. EZReader provides a series of commands along the bottom of the screen, which allows the user to select a single command icon to change to a pre-selected channel. From a list of accessible channels, the up/down arrows allow the user to pass through a series of stored channels. The present system is easier to view than a television because the EZReader screen covers a larger field of vision for the user than a sixty-inch television screened viewed at fifteen feet. A user of this system can enjoy the convenience of switching between media sources (i.e. from email to reader to television) within a single device and platform using simple commonly recognized commands and symbols or icons.

### BRIEF DESCRIPTION OF DRAWINGS

For a more complete understanding of this disclosure and its features, reference is now made to the following description, taken in conjunction with the accompanying drawings, in which:

FIG. 1 shows the EZReader concepts and components;

FIG. 2 shows the Novel File Editor;

FIG. 3 shows High-Speed Word Wrapping;

FIG. 4 a wall-mounted EZReader and user;

FIG. 5 shows Video Device Detection;

FIG. 6 shows Streaming Video Color Modification;

FIG. 7 shows the Camera Application;

FIG. 8 shows Broadcast Message Concept;

FIG. 9 shows Layered Windows of EZReader;

FIG. 10 shows the Custom Print Algorithm;

FIG. 11 shows the sharing of information between applications;

FIG. 12 shows the language translation application;

FIG. 13 shows the EZReader display screen with icons;

FIG. 14 shows an embodiment of the Launch Pad or home screen.

### DETAILED DESCRIPTION OF DRAWINGS

The present disclosure generally provides a System for Consumption and Generation of Media by the Visually Impaired. The figures below demonstrate the features of the present system.

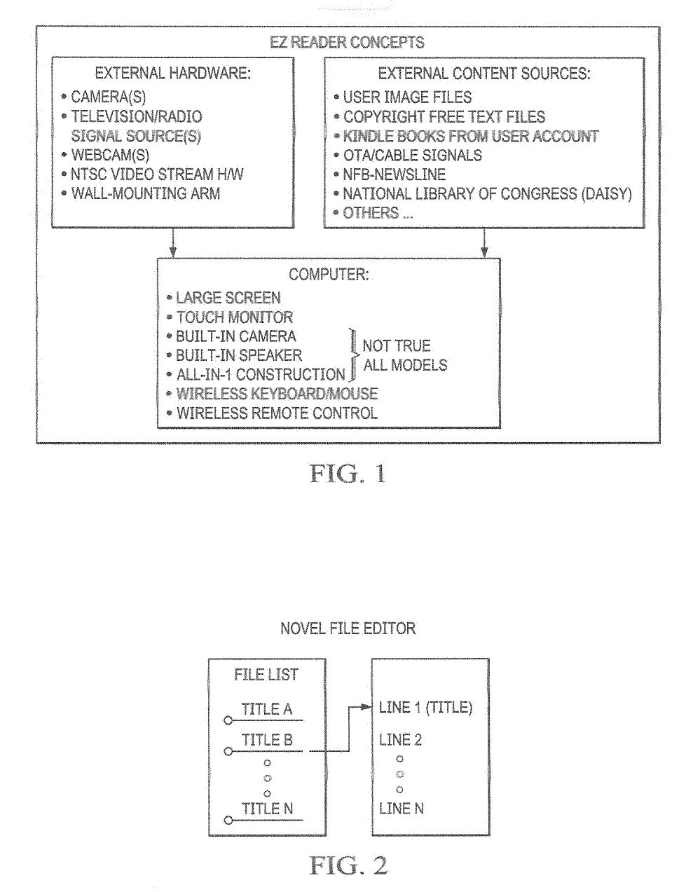

FIG. 1 shows the EZReader concept and components. EZReader is a system for the execution and implementation of the suite of EZReader applications. The EZReader applications replace the existing Windows, or other standard operating system, applications whose screens are incompatible with the needs of low vision users, with EZReader's own applications, which are designed specifically for persons with vision impairments. EZReader additionally includes devices external to the computer to provide media content such as text, images, and video. These external devices include, but are not limited to USB attached webcams, video cards, television and radio tuners and other video stream devices. The external hardware may also include special mounting hardware, such as the extendible arm used to mount an EZReader to a wall. In addition to the devices which provide content, there are additionally a number of online resources through which EZReader can access content. This includes, but is not limited to, content sent via email to the user, copyright-free content available from online sources such a Gutenberg, over-the-air television and radio stations, and magazines and newspapers distributed freely to persons with vision impairments.

FIG. 2 shows the Novel File Editor. EZReader provides a custom text file editor. When a file is saved, EZReader extracts the file name automatically, eliminating the requirement for the user to go through the “File Save As . . . ” process flow. All files are kept in a folder specified by EZReader. The text file editor can provide a list of all available files, from which the user selects a file to open. The EZReader list of available files allows the user to avoid the “File Open . . . ” process flow, which is difficult for a low vision person to navigate. EZReader reviews the first line of the content to be saved to confirm that the first line represents an acceptable file name that is not a duplicate of an existing file. Saving the file will not be allowed until those two criteria are met. The user can create new files which will be given a default name, which corresponds to the first line of content. After the files are saved in file editor, the user can later edit the file names.

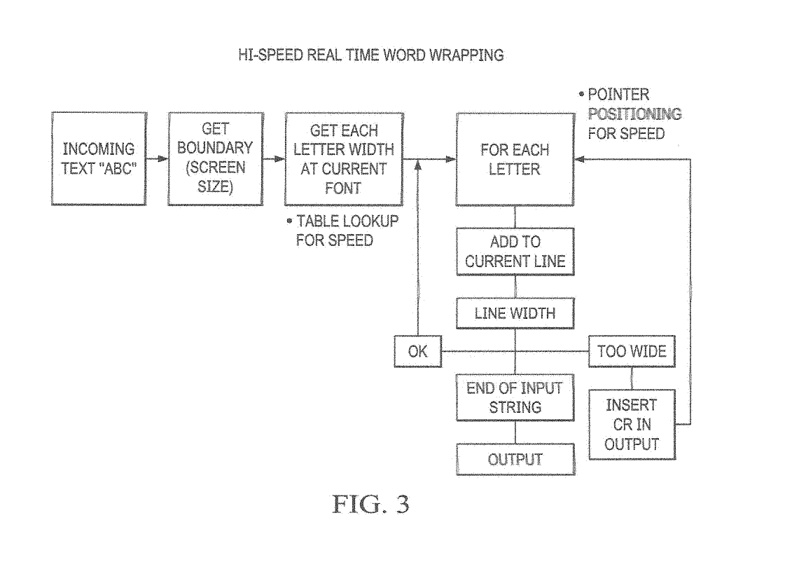

FIG. 3 shows High-Speed Word Wrapping, used in the EZReader applications that display text. EZReader conducts word wrapping to wrap content to the available screen width and avoid the need for both vertical and horizontal wrapping of text. Users can send repetitive commands, such as changing the font size, by quickly tapping multiple times on a command. This allows commands to be sent up to about 5 times per second, meaning that the wrapping algorithm and display must take place in less time in order for the screen to display the expected result of a user command. A novel technique is provided which exceeds the required speed. The approach consists of using pointer-based code algorithms with values located in processor registers to quickly travers the text string. Additionally, the output text is created with only a carriage return (CR) delimiter character, which allows the wrapping function to utilize the unused line feed (LF) character to insert new line markers while moving only the string of the current line. In HTTP protocol, the CRLF sequence is always used to terminate a line. This approach avoids the movement, copy and concatenation of longer, multiple strings to embed a standard CRLF line delimiters, which are then recognized by the page display code. Page display code within EZReader recognizes the single character line delimiters and can display the lines appropriately.

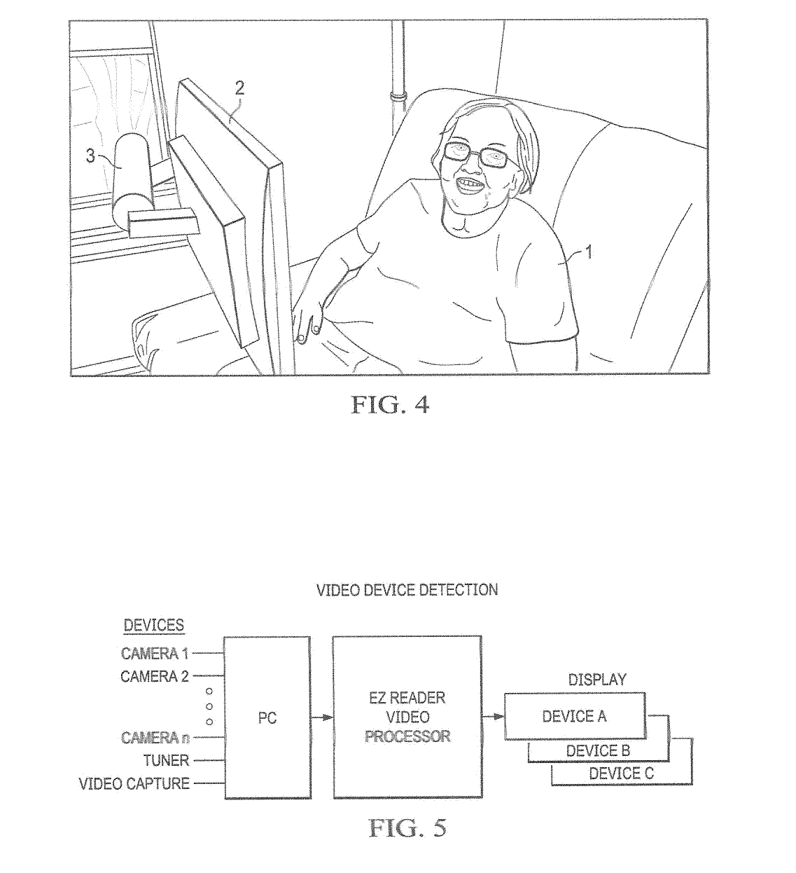

FIG. 4 shows a wall-mounted EZReader and user. Because the EZReader primarily displays text, with minimal graphics generation or animation display, the computer processor needed to operate EZReader can be one of low performance, lowering cost and size of the computer. Particularly, the small computer known as “stick” computers can be used to operate the EZReader system. Stick computers allow a user to turn their television or monitor into a computer (ex: Intel Compute Stick, Asus Chromebit, Lenovo Ideacentre Stick, or any similar device). Due to the light weight of both of the stick computers and touch screen monitor 2, a flexible arm 3 can be used to mount the entire system on the wall-mounted arm 3. The flexible arm 3 allows the user 1 to mount the EZReader flush with the wall when not used and to extend the EZReader out to a comfortable reading position when the user 1 is sitting in a chair, such as a reclining chair. The EZReader can also be placed on a desk or tabletop.

FIG. 5 shows Video Device Detection. EZReader is capable of detecting all types of video devices attached via USB to the computer and of displaying the output of those devices. The user can sequence through the devices, displaying the output of each device. Detectable devices include video capture cards, cameras, webcams, and television and radio capture devices (known as tuners). EZReader can enumerate the devices and acquire hardware information, such as supported image resolutions. EZReader has been adapted for display on 2560×1440, 1920×1080 and 1366×768 pixel resolutions but it is to be understood that other resolutions may be compatible with EZReader.

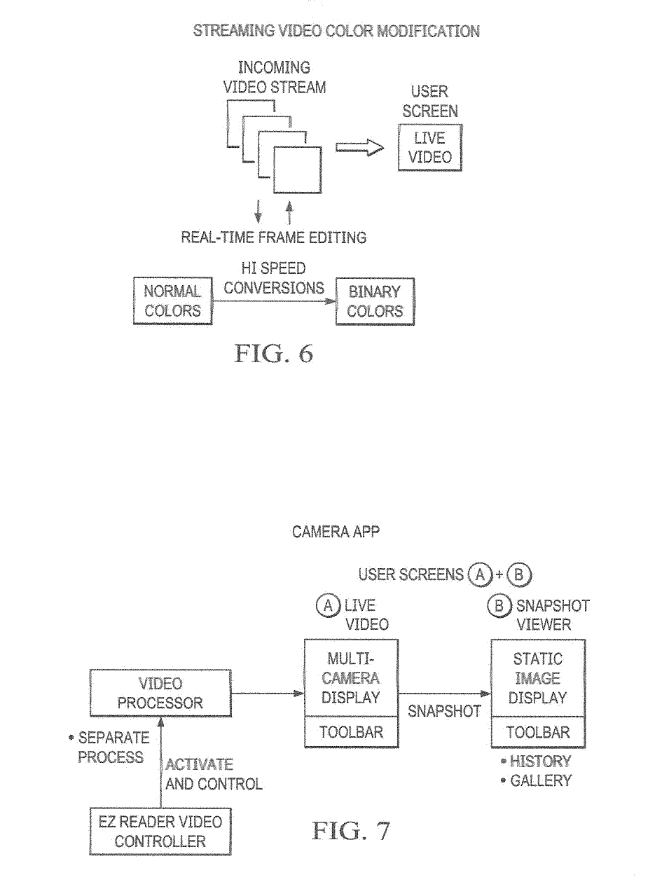

FIG. 6 shows Streaming Video Color Modification. EZReader can modify each frame of the video streams from the devices, manipulating the color information of each frame at high-speeds, without slowing down the frame rates supported by the video devices, even at high density image resolutions. A pointer-based algorithm is used to sequentially modify the color values of each pixel in each frame of the video stream. Both the speed of conversion and the actual conversion of image data to one of two colors, as selected by the user, are not available in the industry.

FIG. 7 shows the Camera Application. EZReader uses a novel method of displaying video outputs in a window, where the windows are created by a first Windows executable file but are controlled by a second EZReader executable file. The video display window is written in a first language (i.e. C#), which provides support for graphics libraries, whereas the controller applications are written in a second language (i.e. Power BASIC), more suited to the development of user interface windows. While C# and PowerBASIC are used in this embodiment, it is to be understood that EZReader can be adapted for other computer languages such as C, C++, C#, PowerBASIC, Java, JavaScript, Ruby, Perl, SQL, PHP, INI and iOS Family. The EZReader video application provides two modes, one in which the user can select and display output via the video window, from any selected camera and another in which the camera image is taken, saved to a file and is available for subsequent viewing within the camera application or within the EZReader Gallery application.

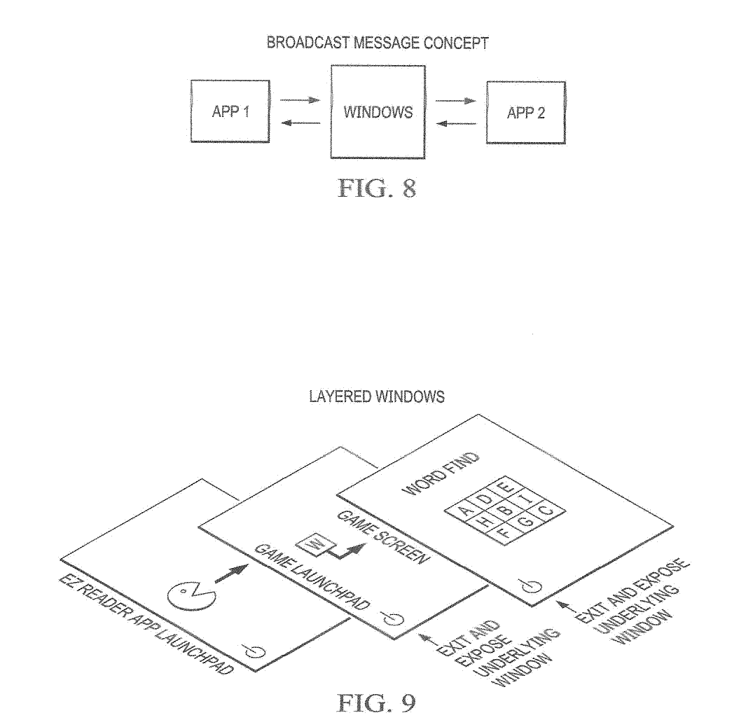

FIG. 8 shows Broadcast Message Concept. The Windows broadcast messages are demonstrative of a “direct”, real-time method of communication. To enable independent development of the features provided by EZReader, a suite of applications was generated rather than one large application. The EZReader suite of applications result in faster development of new features and the isolation of existing features from side effects of new code into EZReader. Because multiple applications may be running at the same time, EZReader uses Windows broadcast message to provide inter-process communication between applications. This is used, for example, to allow EZReader's layered applications to send data or instructions to other EZReader underlying applications to update settings based on a choice made by the user in a separate application within EZReader. Each EZReader application registers one or more common messages using a common registration code enabling EZReader applications to both send and receive broadcast messages. The underlying Windows operating system receives messages from EZReader applications and forwards those broadcast messages to other EZReader applications for action. This Broadcast Message Concept ensures that EZReader applications written in different languages (such as C, C++, C#, PowerBASIC, Java, JavaScript, Ruby, Perl, SQL, PHP, INI and iOS Family) are able to communicate and share data.

FIG. 9 shows Layered Windows of EZReader. As part of isolating the user from the underlying Windows operating system, the EZReader launch pad application, once started, is not terminated when additional EZReader applications are started. A newly started application is run on top of the Launch pad application and increases the graphical quality as perceived by the user. Without the Launch pad window running, closure of other applications also could expose the underlying Windows system momentarily. These brief exposures of Windows would be perceived by users as an annoying “flicker” and would deteriorate the experience of the low vision user. Layering applications ensures that only EZReader windows are visible, even when closing or opening other EZReader applications.

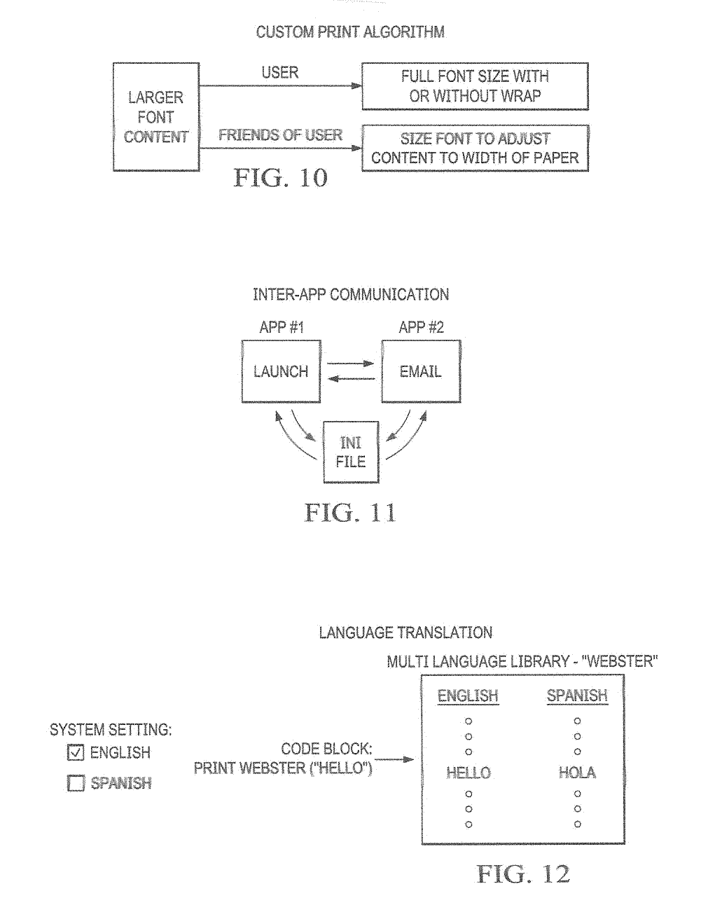

FIG. 10 shows the Custom Print Algorithm. EZReader applications allow the user to print content, which may be intended for the user's or to share with other persons who may not have vision impairments. For the user, EZReader allows printing in the same font settings, with respect to size and color contrast, that make it possible for the user to view the content comfortably in EZReader. But for the person without vision impairments, EZReader can printer the materials using different display parameters, without changing the display settings. Printed materials can be wrapped, which is useful for the user and recipients of printed materials, and the font of the printed materials can be temporarily set to force the longest lines of the content to span the available width of the output media.

FIG. 11 shows Inter-App Communication or information sharing between EZReader applications. EZReader applications can share information via multiple paths. In addition to the direct method shown in FIG. 8. EZReader applications also use multiple methods of exchanging information, such as the Windows clipboard and initialization files (INI files). The Windows clipboard is used to pass information between EZReader applications but clipboard information is lost what an application or window closes. The INI files present an alternative method of exchanging information that is not volatile and will survive between sessions of Windows. All EZReader applications share a common INI file. Values in the INI file, which are changed by one application, will affect any other application using that value (i.e., the FontSize value is stored in the INI file and used by all EZReader applications to determine the text size to display).

FIG. 12 shows the language translation application. EZReader supports the display of multiple languages. A list of all words or text strings displayed by EZReader is maintained in its language library file. The equivalent word in another language is kept in the same language file. The code for displaying a word from that library file, such as “Hello”, is written in code as Print Webster (“Hello”), where Webster is the name of a translation function used by EZReader to scan the language library file for the English word in parentheses (Hello in this instance) and then to return the word from the library corresponding to the English word found in the code. A binary search algorithm is used to find words instantly, so as not to let the user see an apparent slow response to commands for displaying content. EZReader can quickly translate and display content from Spanish, German, Russian, Farsi, Chinese, and any other common world language based on which languages the user uploads to EZReader.

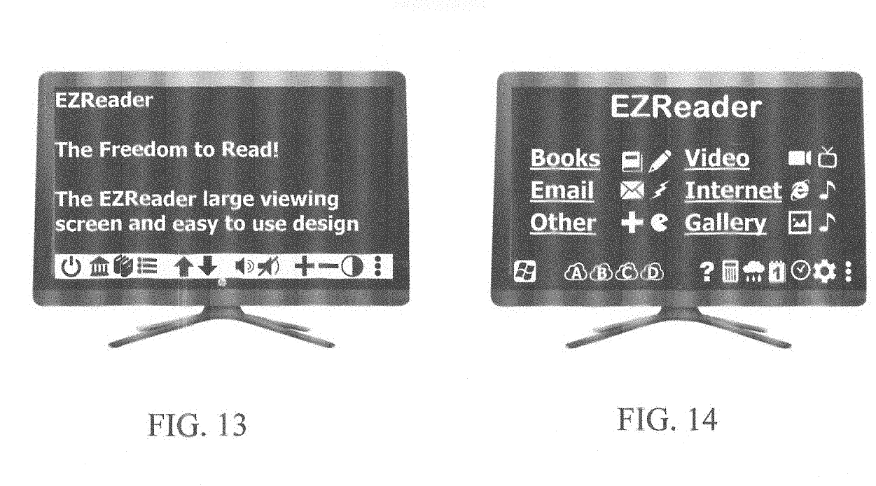

FIG. 13 shows the full screen image of text content on the display screen. Text content may be developed from electronic books, email messages, dictation, or text editor files. The images will the displayed in large font with contrasting binary colors to facilitate viewing by the visually impaired EZReader user. In addition, a selection of large icons is visible at the bottom of the screen. The user may touch the icon to make a selection or connect a mouse and keyboard for selections.

FIG. 14 shows the full screen image of the Launch Pad of the invention and the construction of the computer. The computer for this system contains all components in a single container (monitor, motherboard, power supply, connector ports, and processor). The invention uses large print, contrasting colors, large touch-screen command icons to facilitate viewing by visually impaired users. The system fills the entire screen such that the underlying operating system is not visible or distracting to a reader. The present system would present the LaunchPad screen (i.e. home screen) when the user opens the system and would simplify the navigation and explain the various content/information options that are available. The PC desktop icon can be used to activate the system if it doesn't start automatically as designed. A user would use the touch screen to navigate within the LaunchPad to navigate between components of the system (reader, email, camera, etc.).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure and the following claims.

What is claimed is:

1. A system and method for consumption of media and generation of modified media by visually impaired comprising:
A computer;
Hardware; and
Software applications.

2. The system and method of claim 1, wherein media is content in its original form, wherein modified media is content altered for consumption by visually impaired users.

3. The system and method of claim 1, wherein said media is selected from the group consisting of: textual content, video content, photographic content, digital content, and non-digital content.

4. The system and method of claim 3, wherein said hardware is selected from the group consisting of: mounting arm, computer stick, universal serial bus drive, camera, OCR engine, screen, monitor, remote control, mouse, keyboard, television tuner, antenna, radio, video capture card, and retina scanner.

5. The system and method of claim 4, wherein said software applications is selected from the group consisting of: real-time digitization algorithm, word-wrapping algorithm, video detection, video modification, television, radio, camera, OCR engine, photo resizing, operating system concealment, detection of mobile storage devices, extraction from email attachments, health assessments, technical support, launch pad, dictation, text editor, electronic mail, internet, music player, weather, calculator, calendar, and clock.

6. The system and method of claim 5, wherein said software application are written in code languages selected from the group consisting of: C, C++, C#, PowerBASIC, Java, JavaScript, Ruby, Perl, SQL, PHP, and iOS Family.

7. The system of claim 6, wherein a user submits input to said system from a tool selected from the group consisting of: icons, touch screen, mouse, remote control, keyboard, and verbal commands.

8. The system and method of claim 6, wherein said word wrapping algorithm software application, converts horizontal text content to vertical text content.

9. The system and method of claim 6, wherein said video detection software application displays said media contained on said hardware inserted into said computer on said monitor or said screen.

10. The system and method of claim 6, wherein said video modification software application converts said media to modified media in real time, wherein said modified media is presented in a binary color scheme.

11. The system and method of claim 6, wherein said broadcast message software application facilitates communication between at least two of said software applications, wherein a first software application receives, reads, and acts upon a first message from a second software application, wherein said second software application receives, reads, and acts upon a second message from said first software application.

12. The system and method of claim 6, wherein said operating system concealment software application displays a number of said software applications on said monitor or screen, wherein any underlying operating system remains hidden from said user.

13. The system and method of claim 2, wherein said modified media is altered by traits selected from the group consisting of: color contrast, font, text size, image size, brightness, intra-document navigation links, inter-document content links, and chapter markers.

14. The system and method of claim 5, wherein a home page is customizable, wherein a user selects a number of software applications for display on said home page.

15. The system and method of claim 6, wherein a technical support agent may access, diagnose, and repair said system remotely.
